(19) United States
(12) Patent Application Publication
(10) Pub. No.: US 2025/0203455 A1
(43) Pub. Date: Jun. 19, 2025

(54) METHOD AND DEVICE FOR HEADER COMPRESSION IN WIRELESS COMMUNICATION

(71) Applicants: Yu CHEN, Shanghai (CN); Qiaoling YU, Shanghai (CN); Xiaobo ZHANG, Shanghai (CN)

(72) Inventors: Yu CHEN, Shanghai (CN); Qiaoling YU, Shanghai (CN); Xiaobo ZHANG, Shanghai (CN)

(73) Assignee: SHANGHAI LANGYAO COMMUNICATION TECHNOLOGY COMPANY LIMITED, Shanghai, OT (CN)

(21) Appl. No.: 18/981,676

(22) Filed: Dec. 16, 2024

(30) Foreign Application Priority Data
Dec. 18, 2023 (CN) 202311746953.8

(51) Int. Cl. H04W 28/06; H04W 12/03; H04W 28/02

(52) U.S. Cl. CPC H04W 28/06; H04W 12/03; H04W 28/0268

(57) ABSTRACT

The present application comprising: performing a header compression for a first data SDU at a first protocol layer; and submitting a first data PDU to a second protocol layer, where the first data PDU is generated by the first data SDU having been through the header compression; and performing encryption processing for a second data SDU at the second protocol layer, where the second data SDU is the first data PDU received at the second protocol layer; and submitting a second data PDU to a lower layer, where the second data PDU is generated by the second data SDU having been through the encryption processing; where the first protocol layer is an upper layer of the second protocol layer; the second protocol layer is an upper layer of a MAC layer; the first protocol layer and the second protocol layer are both protocol layers of an access stratum.

### CROSS REFERENCE TO RELATED APPLICATIONS

This application claims the priority benefit of Chinese Patent Application No.202311746953.8, filed on Dec. 18,2023, the full disclosure of which is incorporated herein by reference.

### BACKGROUND

### Technical Field

The present application relates to methods of header compression in wireless communication systems, and in particular to 6G or evolved NR networks.

### Related Art

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary decided to conduct the study of New Radio (NR), or what is called fifth Generation (5G). The work Item (WI) of NR was approved at the 3GPP RAN #75 plenary to standardize the NR.

In communications, both Long Term Evolution (LTE) and 5G NR involves correct reception of reliable information, optimized energy efficiency ratio (EER), determination of information validity, flexible resource allocation, elastic system structure, effective information processing on non-access stratum (NAS), and lower traffic interruption and call drop rate, and support to lower power consumption, which play an important role in the normal communication between a base station and a User Equipment (UE), rational scheduling of resources, and also in the balance of system payload, thus laying a solid foundation for increasing throughput, meeting a variety of traffic needs in communications, enhancing the spectrum utilization and improving service quality. Therefore, LTE and 5G are indispensable no matter in enhanced Mobile BroadBand (eMBB), Ultra Reliable Low Latency Communication (URLLC) or enhanced Machine Type Communication (eMTC). And a wide range of requests can be found in terms of Industrial Internet of Things (IIoT), Vehicular to X (V2X), and Device to Device (D2D), Unlicensed Spectrum communications, and monitoring on UE communication quality, network plan optimization, Terrestrial Network (TN), Dual connectivity system, radio resource management and multi-antenna codebook selection, as well as signaling design, neighbor management, traffic management and beamforming. Information is generally transmitted by broadcast and unicast, and both ways are beneficial to fulfilling the above requests and make up an integral part of the 5G system.

As the number and complexity of system scenarios increases, more and more requests have been made on reducing interruption rate and latency, strengthening reliability and system stability, increasing the traffic flexibility and power conservation, and in the meantime the compatibility between different versions of systems shall be taken into account for system designing.

Refer to 3GPP specifications for the concepts, terminology and abbreviations given in the present application, including but not limited to:
https://www.3gpp.org/ftp/Specs/archive/21_series/21.905/21905-h10.zip
https://www.3gpp.org/ftp/Specs/archive/38_series/38.300/38300-h10.zip
https://www.3gpp.org/ftp/Specs/archive/38_series/38.331/38331-h10.zip
https://www.3gpp.org/ftp/Specs/archive/38_series/38.323/38323-h10.zip
https://www.3gpp.org/ftp/Specs/archive/38_series/38.322/38322-h10.zip
https://www.3gpp.org/ftp/Specs/archive/37_series/37.324/37324-h10.zip
https://www.3gpp.org/ftp/Specs/archive/33_series/33.501/333501-h10.zip

### SUMMARY

Researchers have found that in scenarios where header compression and encryption are supported in the Access Stratum (AS), the determination of which protocol layers are for the implementation of header compression and which are for encryption among the multiple protocol layers above the MAC layer is a problem that needs to be solved.

To address the problem presented above, the present application provides a solution.

It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict. Also, the method presented in this application can be used to solve other problems in communications, such as in NR evolution (further evolved NR) and especially in 6G systems.

In one embodiment, interpretations of the terminology in the present application refer to definitions given in the 3GPP TS38 series.

In one embodiment, interpretations of the terminology in the present application refer to definitions given in the 3GPP TS37 series.

The present application provides a method in a first node for wireless communications, comprising:
performing a header compression for a first data Service Data Unit (SDU) at a first protocol layer; and submitting a first data Protocol Data Unit (PDU) to a second protocol layer, where the first data PDU is generated by the first data SDU having been through the header compression; and performing encryption processing for a second data SDU at the second protocol layer, where the second data SDU is the first data PDU received at the second protocol layer; and submitting a second data PDU to a lower layer, where the second data PDU is generated by the second data SDU having been through the encryption processing;
herein, the first protocol layer is an upper layer of the second protocol layer; the second protocol layer is an upper layer of a MAC layer; the first protocol layer and the second protocol layer are both protocol layers of an access stratum; service provided by the second protocol layer to the first protocol layer is a radio bearer.

In one embodiment, a problem to be solved in the present application includes that in which of the multiple protocol layers above the MAC layer in the AS header compression is implemented, and which of the multiple protocol layers encryption is implemented is a problem to be solved.

In one embodiment, the benefits of the above method include: having higher efficiency, and providing better support for 6G services, as well as network architecture, and user-plane requirements; showing more flexibility, and providing better support for richer services, better support for multi-modality services, providing better compatibility and more flexible QoS.

Specifically, according to one aspect of the present application, performing a header compression for a third data SDU at the first protocol layer; and submitting a third data PDU to the second protocol layer, where the third data PDU is generated by the third data SDU having been through the header compression;
herein, the phrase submitting a first data PDU to a second protocol layer comprises: submitting the first data PDU to a first protocol entity of the second protocol layer; and the phrase submitting a third data PDU to the second protocol layer comprises: submitting the third data PDU to the first protocol entity of the second protocol layer; the header compression performed at the first protocol layer for the first data SDU and the header compression performed at the first protocol layer for the third data SDU use different header compression profiles.

Specifically, according to one aspect of the present application, the first data SDU and the third data SDU use different Internet Protocol (IP) addresses; the first data SDU and the third data SDU correspond to different Quality of Service (QoS) flows or different QoS sub-flows.

Specifically, according to one aspect of the present application, performing a header compression for a third data SDU at the first protocol layer; and submitting a third data PDU to the second protocol layer, where the third data PDU is generated by the third data SDU having been through the header compression;
herein, the phrase submitting a first data PDU to a second protocol layer comprises: submitting the first data PDU to a first protocol entity of the second protocol layer; and the phrase submitting a third data PDU to the second protocol layer comprises: submitting the third data PDU to the second protocol entity of the second protocol layer; the first data SDU and the third data SDU correspond to a same QoS flow.

Specifically, according to one aspect of the present application, performing segmentation for the second data SDU at the second protocol layer;
herein, the second protocol layer is a PDCP layer.

Specifically, according to one aspect of the present application, performing a second header compression for the second data SDU at the second protocol layer, where the second header compression is a header compression other than based on RoHC;
herein, the header compression performed at the first protocol layer for the first data SDU is a first header compression based on RoHC.

Specifically, according to one aspect of the present application, the first protocol layer is an SDAP layer.

Specifically, according to one aspect of the present application, the second protocol layer is a PDCP layer.

Specifically, according to one aspect of the present application, the first protocol layer supports mapping between a QoS flow and a radio bearer, and supports marking a QoS flow identity.

Specifically, according to one aspect of the present application, the second protocol layer supports Sequence Number, supports integrity protection, supports replication and supports packet discarding.

Specifically, according to one aspect of the present application, the first protocol layer and the second protocol layer are both protocol layers above RLC.

Specifically, according to one aspect of the present application, the first node is a terminal of Internet of Things (IoT).

Specifically, according to one aspect of the present application, the first node is a UE.

Specifically, according to one aspect of the present application, the first node is an access-network device.

Specifically, according to one aspect of the present application, the first node is a vehicle-mounted terminal.

Specifically, according to one aspect of the present application, the first node is a cellphone.

The present application provides a first node for wireless communications, comprising:
a first transmitter, performing a header compression for a first data SDU at a first protocol layer; and submitting a first data PDU to a second protocol layer, where the first data PDU is generated by the first data SDU having been through the header compression; and performing encryption processing for a second data SDU at the second protocol layer, where the second data SDU is the first data PDU received at the second protocol layer; and submitting a second data PDU to a lower layer, where the second data PDU is generated by the second data SDU having been through the encryption processing;
herein, the first protocol layer is an upper layer of the second protocol layer; the second protocol layer is an upper layer of a MAC layer; the first protocol layer and the second protocol layer are both protocol layers of an access stratum; service provided by the second protocol layer to the first protocol layer is a radio bearer.

In one embodiment, compared with the prior art, the present application is advantageous in the following aspects:

The 6G network will support more various service forms, which challenges both the network architecture and the user plane. The method proposed in this application is conducive to enhancing the flexibility of the first protocol layer and the second protocol layer, and at the same time, it can better support the transmission of complex services, such as multi-modality services, especially those complex services that use different TCP/IP headers.

It is favorable to simplify the design of the second protocol layer, reduce the complexity and shorten the processing delay.

It can better support the transmission of services based on PDU sets, such as XR (i.e., extended Reality).

It maintains the relative independence of each layer of the protocol, which is conducive to the implementation of deployment debugging and standardization.

It can better support the application of Artificial Intelligence (AI) in accessing.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of performing header compression for a first data SDU at a first protocol layer, submitting a first data PDU to a second protocol layer, encrypting a second data SDU at the second protocol layer, and submitting a second data PDU to a lower layer, according to one embodiment of the present application.

FIG. 2 illustrates a schematic diagram of a network architecture according to one embodiment of the present application.

FIG. 3 illustrates a schematic diagram of a radio protocol architecture of a user plane and a control plane in NR network according to one embodiment of the present application.

FIG. 4 illustrates a schematic diagram of a first communication device and a second communication device according to one embodiment of the present application.

FIG. 5 illustrates a flowchart of radio signal transmission according to one embodiment of the present application.

FIG. 6 illustrates a schematic diagram of a user-plane processing procedure according to one embodiment of the present application.

FIG. 7 illustrates a schematic diagram of a first protocol layer and a second protocol layer according to one embodiment of the present application.

FIG. 8 illustrates a schematic diagram of a first protocol layer and a second protocol layer according to one embodiment of the present application.

FIG. 9 illustrates a schematic diagram of a first protocol layer and a second protocol layer according to one embodiment of the present application.

FIG. 10 illustrates a structure block diagram of a processing device in a first node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

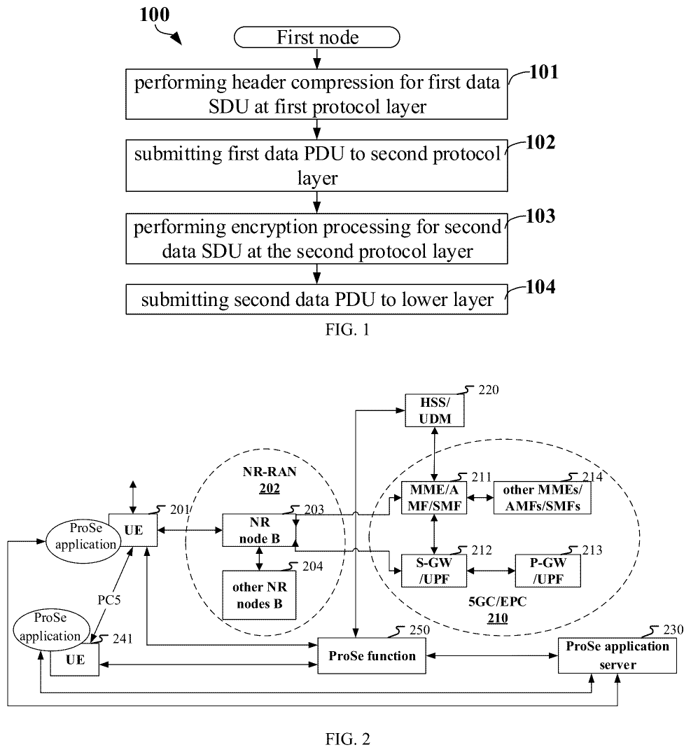

Embodiment 1 illustrates a flowchart of performing header compression for a first data SDU at a first protocol layer, submitting a first data PDU to a second protocol layer, encrypting a second data SDU at the second protocol layer, and submitting a second data PDU to a lower layer, according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node of the present application performs header compression for a first data SDU at a first protocol layer in step 101, submits a first data PDU to a second protocol layer in step 102, encrypts a second data SDU at the second protocol layer in step 103, and submits a second data PDU to a lower layer in step 104;
herein, the first data PDU is generated by the first data SDU having been through the header compression; the second data SDU is the first data SDU received at the second protocol layer; and the second data PDU is generated by the second data SDU having been through the encryption processing; the first protocol layer is an upper layer of the second protocol layer; the second protocol layer is an upper layer of a MAC layer; the first protocol layer and the second protocol layer are both protocol layers of an access stratum; service provided by the second protocol layer to the first protocol layer is a radio bearer.

In one embodiment, the first node is a User Equipment (UE).

In one embodiment, the first node is in an RRC connected state.

In one embodiment, the first node is in an RRC inactive state.

In one embodiment, higher layer PDUs received from a higher layer are SDUs of current protocol layers.

In one embodiment, the higher layer PDUs are SDUs of the current protocol layers.

In one subembodiment, the higher layer is a layer above the current protocol layers.

In one subembodiment, the higher layer is no other protocol layer being present between the current protocol layers.

In one embodiment, the first protocol layer processes a received SDU to generate a PDU for the first protocol layer.

In one embodiment, the second protocol layer processes a received SDU to generate a PDU for the second protocol layer.

In one embodiment, the Access Stratum (AS) is a neutral term in the art.

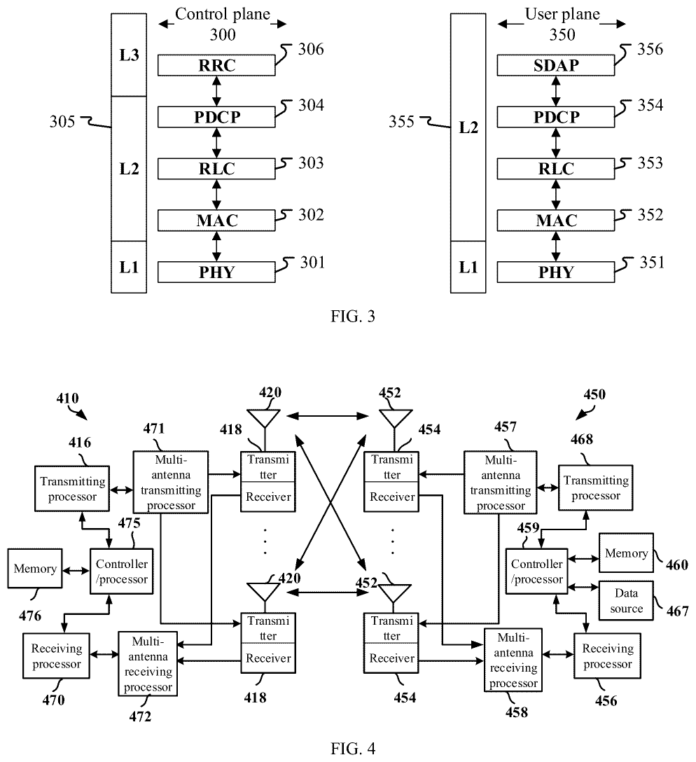

In one embodiment, in the NR, the protocol layer or protocol sublayer included in the Access Stratum (AS) corresponds to FIG. 3 of the accompanying drawings, but in the 6G system, the name of the protocol layer or protocol sublayer included in the AS may be different.

In one embodiment, the Access Stratum (AS) is functionally combined and comprises parts belonging to the basic settings and in the user equipment, including protocols between the parts, the protocols being particularly related to the access technology.

In one embodiment, the protocols included in the Access Stratum (AS) terminate in terminal and radio access network.

In one embodiment, the protocols included in the Access Stratum (AS) terminate in terminal and a serving cell.

In one embodiment, the protocols included in the Access Stratum (AS) terminate in terminal and a base station.

In one embodiment, distinguishing from the Access Stratum (AS), the protocols included in the Non-Access Stratum terminate at a user terminal and the core network.

In one embodiment, distinguishing from the Access Stratum (AS), the protocols included in the application layer terminate at a user terminal and an external application server.

In one subembodiment, the external application server comprises a server on the Internet.

In one embodiment, the protocol layer in this application may also be referred to as a protocol sub-layer.

In one embodiment, any parameter in the present application is either configured by the network or may be generated by the first node according to an internal algorithm, e.g. randomization.

In one embodiment, the value of any parameter in this application, including, but not limited to, the value of a timer or the value of a counter, unless specifically stated, is limited.

In one subembodiment, an upper limit of the value of any parameter in this application is 1024 times 65536.

In one subembodiment, an upper limit of the value of any parameter in this application is 65536 or 65535.

In one subembodiment, an upper limit of the value of any parameter in this application is 1024.

In one subembodiment, an upper limit of the value of any parameter in this application is 640 or 320.

In one embodiment, the present application is for NR evolved wireless communication networks.

In one embodiment, the present application is for 6G wireless communication networks.

In one embodiment, the NR evolution may also be referred to as 6G.

In one embodiment, the NR evolution is a next generation wireless communication technology for NR.

In one embodiment, a serving cell refers to a cell that the UE is camped on. Performing cell search includes that the UE searches for a suitable cell for a selected Public Land Mobile Network (PLMN) or Stand-alone Non-Public Network (SNPN), selects the suitable cell to provide available services, and monitors a control channel of the suitable cell, where the whole procedure is defined to be camped on the cell; in other words, relative to this UE, the cell being camped on is seen as a serving cell of the UE. Camping on a cell in either RRC_Idle state or RRC_Inactive state has the following benefits: it allows the UE to receive system messages from the PLMN or SNPN; when registered, if the UE wishes to establish an RRC connection or continue a suspending RRC connection, the UE can do so by performing an initial access on the control channel of the camped cell; the network can page the UE; it allows the UE to receive Earthquake and Tsunami Warning System (ETWS) and Commercial Mobile Alert System (CMAS) notifications.

In one embodiment, for a UE in RRC connected state without being configured with carrier aggregation/dual connectivity (CA/DC), there is only one serving cell that comprises a primary cell. For a UE in RRC connected state that is configured with carrier aggregation/dual connectivity (CA/DC), a serving cell is used for indicating a cell set comprising a Special Cell (SpCell) and all secondary cells. A Primary Cell is a cell in a Master Cell Group (MCG), i.e., an MCG cell, working on the primary frequency, and the UE performs an initial connection establishment procedure or initiates a connection re-establishment on the Primary Cell. For dual connectivity (DC) operation, a special cell refers to a Primary Cell (PCell) in an MCG or a Primary SCG Cell (PSCell) in a Secondary Cell Group (SCG); otherwise, the special cell refers to a PCell.

In one embodiment, working frequency of a Secondary Cell (SCell) is secondary frequency.

In one embodiment, separate contents in information elements (IEs) are referred to as fields.

In one embodiment, Multi-Radio Dual Connectivity (MR-DC) refers to dual connectivity with an E-UTRA node and an NR node, or with two NR nodes.

In one embodiment, in MR-DC, a radio access node providing a control plane connection to the core network is a master node, where the master node can be a master eNB, a master ng-eNB or a master gNB.

In one embodiment, an MCG refers to a group of serving cells associated with a master node in MR-DC, including a SpCell, and optionally, one or multiple SCells.

In one embodiment, a PCell is a SpCell of an MCG.

In one embodiment, a PSCell is a SpCell of an SCG.

In one embodiment, in MR-DC, a radio access node not providing a control plane connection to the core network but providing extra resources for the UE is a secondary node. The secondary node can be an en-gNB, a secondary ng-eNB or a secondary gNB.

In one embodiment, in MR-DC, a group of serving cells associated with a secondary node is a secondary cell group (SCG), including a SpCell and, optionally, one or multiple SCells.

In one embodiment, the SpCell is a PCell or the SpCell is a PSCell.

In one embodiment, DC is not used in the RRC inactive state.

In one embodiment, CA is typically not used in the RRC inactive state.

In one embodiment, an RRC information block refers to an information block (information element) in an RRC message.

In one embodiment, an SSB may be referred to as an SS\PBCH, or SS block.

In one embodiment, L1 is Layer-1 or the physical layer.

In one embodiment, the present application is intended for the networks of NR evolution, such as 6G networks.

In one embodiment, an RRC information block may include one or more RRC information blocks.

In one embodiment, an RRC information block does not have to include any RRC information block, but only includes at least one parameter.

In one embodiment, radio bearers include at least a signaling radio bearer and a data radio bearer.

In one embodiment, a radio bearer is a service or an interface to service provided by the second protocol layer to an upper layer of the second protocol layer.

In one embodiment, a signaling radio bearer is a service or an interface to service provided by the second protocol layer to an upper layer of the second protocol layer.

In one subembodiment, the upper layer of the second protocol layer comprises at least the former of an RRC layer or a NAS.

In one embodiment, a data radio bearer is a service or an interface to service provided by the second protocol layer to an upper layer of the second protocol layer.

In one subembodiment, the upper layer of the second protocol layer comprises the first protocol layer.

In one embodiment, the first node enters the RRC connected state when the first node has established an RRC connection with the network.

In one subembodiment, the network is a radio access network (RAN).

In one embodiment, after the first node has not established an RRC connection with the network, the first node is in the RRC idle state.

In one subembodiment, the network is a radio access network (RAN).

In one embodiment, the first node enters the RRC inactive state after the first node is suspended from establishing an RRC connection with the network.

In one subembodiment, the network is a radio access network (RAN).

In one embodiment, different functions are supported in different RRC states.

In one embodiment, only very limited functionality is supported in the non-RRC connected state.

In one embodiment, the non-RRC connected state is or includes RRC idle state.

In one embodiment, the non-RRC connected state is or includes RRC inactive state.

In one embodiment, the present application applies to RRC connected state.

In one embodiment, the present application is not for RRC idle state.

In one embodiment, the first protocol layer supports mapping between QoS flows and radio bearers.

In one embodiment, the first protocol layer supports marking QoS flow IDs.

In one embodiment, that the first protocol layer supports mapping between a QoS flow and a radio bearer means that the first protocol layer uses a mapping function between QoS flows and radio bearers.

In one embodiment, that the first protocol layer supports mapping between a QoS flow and a radio bearer means that the first protocol layer's functionality includes mapping between QoS flows and radio bearers.

In one embodiment, that the first protocol layer supports mapping between a QoS flow and a radio bearer means that along with the performance of the header compression for a first data SDU at a first protocol layer, a QoS flow to which the first data SDU belongs is mapped to a first radio bearer at the first protocol layer.

In one embodiment, the meaning of that the first protocol layer supports marking QoS flow IDs comprises: the first protocol layer using a function of marking QoS flow identities.

In one embodiment, the meaning of that the first protocol layer supports marking QoS flow IDs comprises: the first protocol layer's functionality includes marking QoS flow identities.

In one embodiment, the meaning of that the first protocol layer supports marking QoS flow IDs comprises: accompanying the performance of the header compression for a first data SDU at a first protocol layer, the first node marking QoS flow identities at the first protocol layer.

In one embodiment, the first protocol layer is an adaptation protocol layer.

In one embodiment, the first protocol layer is an adaptation protocol regarding service data.

In one embodiment, the first protocol layer is a Service Data Adaptation Protocol (SDAP) layer.

In one embodiment, there are no other protocol layers between the first protocol layer and the second protocol layer.

In one embodiment, there are no other protocol sublayers between the first protocol layer and the second protocol layer.

In one embodiment, there is a direct interface between the first protocol layer and the second protocol layer.

In one embodiment, a PDU generated by the first protocol layer is an SDU of the second protocol layer.

In one embodiment, the first data SDU is a data SDU.

In one embodiment, the first data SDU is not RRC generated.

In one embodiment, the first data SDU is not anon access stratum (NAS) signaling.

In one embodiment, the first data SDU is generated by the application layer of the first node.

In one embodiment, the first data SDU is generated by the IP layer of the first node.

In one embodiment, a header of the first data SDU carries an IP address.

In one embodiment, the first data SDU belongs to a QoS flow.

In one embodiment, the first data SDU belongs to a QoS sub-flow.

In one embodiment, the first data SDU is uplink data.

In one embodiment, the first data SDU is sent to the second protocol layer via a first data radio bearer.

In one embodiment, a person skilled in the art should understand at least one header compression protocol.

In one embodiment, a person skilled in the art should understand at least one method of header compression using a header compression protocol.

In one embodiment, the header compression is used to compress a header of the first data SDU.

In one embodiment, the header compression is used to save transmission resources.

In one embodiment, the header compression performed for the first data SDU at the first protocol layer comprises header compression performed using Robust Header Compression (RoHC).

In one embodiment, the protocols related to RoHC can be found in IETF RFC 5795, IETF RFC 3095, IETF RFC 4815, IETF RFC 6846, and IETF RFC 5225.

In one embodiment, the RoHC is prior art.

In one embodiment, the header compression performed for the first data SDU at the first protocol layer comprises header compression using Ethernet Header Compression (EHC).

In one embodiment, the header compression performed for the first data SDU at the first protocol layer comprises header compression using Uplink Data Compression (UDC).

In one embodiment, the first protocol layer and the second protocol layer have an interface between them.

In one embodiment, the first protocol layer and the second protocol layer have a service access point between them.

In one embodiment, the action submitting a first data PDU to a second protocol layer is to submit via an interface or a service access point between the first protocol layer and the second protocol layer.

In one embodiment, the first data PDU is a data PDU.

In one embodiment, the first data PDU is not RRC generated.

In one embodiment, the first data PDU is not a non-access stratum (NAS) signaling.

In one embodiment, the first data PDU carries an IP address.

In one embodiment, the first data PDU belongs to a QoS flow.

In one embodiment, the first data PDU belongs to a QoS sub-flow.

In one embodiment, the first data PDU is uplink data.

In one embodiment, the first data PDU uses a first data radio bearer.

In one embodiment, the first data PDU is transmitted over a first data radio bearer.

In one embodiment, that the first data PDU is generated by the first data SDU having been through the header compression comprises: the first data SDU having been through the header compression is the first data PDU.

In one embodiment, that the first data PDU is generated by the first data SDU having been through the header compression comprises: the first data SDU having been through the header compression is encapsulated to be the first data PDU.

In one embodiment, that the first data PDU is generated by the first data SDU having been through the header compression comprises: the first data SDU having been through the header compression and the header of the first protocol layer make up the first data PDU.

In one embodiment, that the first data PDU is generated by the first data SDU having been through the header compression comprises: the first data SDU having been through the header compression and the header of the first protocol layer are encapsulated together to be the first data PDU.

In one embodiment, that the first data PDU is generated by the first data SDU having been through the header compression comprises: the first data PDU carries the first data SDU.

In one embodiment, the meaning of that the second data PDU is generated by the second data SDU having been through the encryption processing comprises: the second data SDU having been through the encryption processing is the second data PDU.

In one embodiment, the meaning of that the second data PDU is generated by the second data SDU having been through the encryption processing comprises: the second data SDU having been through the encryption processing and the protocol header of the second protocol layer make up the second data PDU.

In one embodiment, the meaning of that the second data PDU is generated by the second data SDU having been through the encryption processing comprises: the second data SDU having been through the encryption processing and the protocol header of the second protocol layer are encapsulated together to become the second data PDU.

In one embodiment, the meaning of that the second data PDU is generated by the second data SDU having been through the encryption processing comprises: the second data PDU carries the second data SDU.

In one embodiment, the second data SDU is the first data PDU.

In one embodiment, when the first data PDU is received by the second protocol layer, for the second protocol layer the first data PDU is the second data SDU.

In one embodiment, the meaning of that the second data SDU is the first data SDU received at the second protocol layer comprises that the second data SDU is the first data PDU received by the second protocol layer from the first protocol layer.

In one embodiment, the meaning of that the second data SDU is the first data SDU received at the second protocol layer comprises that the receiving at the second protocol layer corresponds to the submitting the first data PDU to the second protocol layer.

In one embodiment, the performing encryption processing for a second data SDU at the second protocol layer comprises encrypting the second data SDU.

In one embodiment, a person skilled in the art should have knowledge of at least one encryption method.

In one embodiment, the performing encryption processing for a second data SDU at the second protocol layer does not limit the encryption algorithm.

In one embodiment, the encryption algorithm used in the encryption processing of the second data SDU performed at the second protocol layer comprises one of AES, SNOW, ChaCha.

In one embodiment, a person skilled in the art should understand that the first node and the network may need to engage in signaling interactions including handshaking prior to the encryption processing of the second data SDU at the second protocol layer.

In one embodiment, the action submitting a second data PDU to a lower layer comprises: submitting the second data PDU to a lower layer of the second protocol layer via an interface or service access point between the second protocol layer and the lower layer of the second protocol layer.

In one embodiment, the lower layer in the action submitting a second data PDU to a lower layer is a lower layer of the second protocol layer.

In one embodiment, there is no other protocol layer between the lower layer in the action submitting a second data PDU to a lower layer and the second protocol layer.

In one embodiment, there is no other protocol sub-layer between the lower layer in the action submitting a second data PDU to a lower layer and the second protocol layer.

In one embodiment, the lower layer in the action submitting a second data PDU to a lower layer is an RLC layer.

In one embodiment, the lower layer in the action submitting a second data PDU to a lower layer is a MAC layer.

In one embodiment, the interface between the second protocol layer and the lower layer of the second protocol layer is a logical channel.

In one embodiment, a protocol header of the second data PDU indicates that the second data PDU is a data type PDU.

In one embodiment, a protocol header of the second data PDU does not indicate that the second data PDU is a data type PDU.

In one embodiment, the second data PDU is sent over a traffic channel to a lower layer of the second protocol layer.

In one subembodiment, PDUs sent over the traffic channel to the lower layer of the second protocol layer are all data PDUs.

In one subembodiment, the traffic channel is a downlink traffic channel (DTCH).

In one embodiment, since the second data SDU is a data type SDU, the PDU generated by the second data SDU, i.e. the second data PDU, is a data PDU.

In one embodiment, the first data PDU uses a data radio bearer and therefore the first data PDU is a data type PDU.

In one embodiment, the second data SDU uses a data radio bearer and therefore the second data SDU is a data type PDU.

In one embodiment, the second data SDU is the first data PDU and the first data PDU is a data type PDU, hence the second data SDU is a data type SDU.

In one embodiment, the meaning that the first protocol layer is an upper layer of the second protocol layer comprises that the first protocol layer is higher than the second protocol layer.

In one embodiment, the meaning that the first protocol layer is an upper layer of the second protocol layer comprises that the first protocol layer is above the second protocol layer.

In one embodiment, the meaning that the first protocol layer is an upper layer of the second protocol layer comprises that when transmitting, data is submitted by the first protocol layer to the second protocol layer.

In one embodiment, the meaning that the first protocol layer is an upper layer of the second protocol layer comprises that when receiving, data is submitted by the second protocol layer to the first protocol layer.

In one embodiment, the meaning of the second protocol layer being an upper layer of a MAC layer is that the second protocol layer is above the MAC layer.

In one embodiment, there is no other protocol layer between the second protocol layer and the MAC layer.

In one embodiment, there is/are other protocol layer(s) between the second protocol layer and the MAC layer.

In one subembodiment, the other protocol layer is an RLC layer.

In one embodiment, that the service provided by the second protocol layer to the first protocol layer is a radio bearer means that the interface between the first protocol layer and the second protocol layer is a radio bearer.

In one embodiment, the second protocol layer supports sequence numbers.

In one embodiment, a protocol header of a data PDU generated by the second protocol layer comprises a sequence number.

In one embodiment, the header of the second data PDU comprises a sequence number.

In one embodiment, the header of the second data PDU comprises a sequence number field.

In one embodiment, the second protocol layer supports integrity protection.

In one embodiment, the functionality of the second protocol layer comprises integrity protection.

In one embodiment, the second protocol layer supporting integrity protection comprises performing integrity protection processing on the second data SDU.

In one embodiment, accompanied by encryption processing of a second data SDU at the second protocol layer, the first node performs integrity protection processing of the second data SDU at the second protocol layer.

In one embodiment, the second protocol layer supports replication.

In one embodiment, the functionality of the second protocol layer comprises replication.

In one embodiment, the replication supported by the second protocol layer is to replicate SDUs of the second protocol layer and transmit them over multiple paths to enhance performance, e.g. to increase reliability.

In one embodiment, packet discarding is supported by the second protocol layer.

In one embodiment, when an SDU that has been sent out via one path is acknowledged to have been received by the opposite end, the protocol entity of the second protocol layer indicates the deletion of SDU(s) that has/have been transmitted and replicated via other path(s).

In one embodiment, the second protocol layer is a protocol layer related to packet data.

In one embodiment, the second protocol layer is a packet data convergence protocol layer.

In one embodiment, the second protocol layer is a PDCP (i.e., Packet Data Convergence Protocol) layer.

In one embodiment, when the access stratum includes an RLC layer, the second protocol layer is a protocol layer above the RLC.

In one subembodiment, there is no other protocol layer between the second protocol layer and the RLC layer.

In one subembodiment, when the access stratum does not include an RLC layer, no other protocol layer is included between the second protocol layer and the MAC layer.

In one subembodiment, the second protocol layer is a PDCP layer.

In one embodiment, when the access stratum does not include an RLC layer, no other protocol layer is included between the second protocol layer and the MAC layer.

In one subembodiment, the second protocol layer is a PDCP layer.

In one embodiment, the above method is advantageous in that it can better support the requirements of 6G systems and reduce the processing delay.

In one embodiment, the first protocol layer and the second protocol layer are both protocol layers below the IP layer.

In one embodiment, a peer protocol layer of the first protocol layer is in a RAN.

In one embodiment, a peer protocol layer of the first protocol layer is in a cell.

In one embodiment, a peer protocol layer of the first protocol layer is in a base station.

In one embodiment, a peer protocol layer of the second protocol layer is in a RAN.

In one embodiment, a peer protocol layer of the second protocol layer is in a cell.

In one embodiment, a peer protocol layer of the second protocol layer is in a base station.

In one embodiment, the first node, at the lower layer, transmits the second data PDU over an air interface.

In one embodiment, the phrase transmitting the second data PDU over the air interface is transmitting to a serving cell.

### Embodiment 2

Embodiment 2 illustrates a schematic diagram of a network architecture according to the present application, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called a 5G System/Evolved Packet System (5GS/EPS) 200 or other suitable terminology. The 5GS/EPS 200 may comprise one or more UEs 201, an NG-RAN 202, a 5G-Core Network/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The NG-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1 /NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the first node in the present application is the UE 201.

In one embodiment, a base station of the second node in the present application is the gNB203.

In one embodiment, a radio link from the UE 201 to the NR Node B is an uplink.

In one embodiment, a radio link from the NR Node B to the UE 201 is a downlink.

In one embodiment, the UE 201 includes cellphone.

In one embodiment, the UE 201 is a means of transportation including automobile.

In one embodiment, the gNB 203 is a MacroCellular base station.

In one embodiment, the gNB203 is a Micro Cell base station.

In one embodiment, the gNB203 is a Pico Cell base station.

In one embodiment, the gNB203 is a flight platform.

In one embodiment, the gNB203 is satellite equipment.

### Embodiment 3

Embodiment 3 illustrates a schematic diagram of an embodiment of a radio protocol architecture of a user plane and a control plane in NR network, as shown in FIG. 3. FIG. 3 is a schematic diagram illustrating an embodiment of a radio protocol architecture of a user plane 350 and a control plane 300. In FIG. 3, the radio protocol architecture for a control plane 300 used for a first node (UE, gNB) and a second node (gNB, UE), or between two UEs, is represented by three layers, which are layer 1, layer 2 and layer 3. The layer 1 (L1) is the lowest layer which performs signal processing functions of various PHY layers. The L1 is called PHY 301 in the present application. The layer 2 (L2) 305 is above the PHY 301, and is in charge of the link between a first node and a second node as well as between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second nodes. The PDCP sublayer 304 provides multiplexing among variable radio bearers and logical channels. The PDCP sublayer 304 provides security by encrypting packets and also support for inter-cell handover of the first node between second nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. In the control plane 300, the RRC sublayer 306 in the L3 layer is responsible for acquiring radio resources (i.e., radio bearer) and configuring the lower layer using an RRC signaling between the second node and the first node. The PC5 Signaling (PC5-S) Protocol sublayer 307 is responsible for the signaling protocol processing of the PC5 interface. The radio protocol architecture in the user plane 350 comprises the L1 layer and the L2 layer. In the user plane 350, the radio protocol architecture used for the first node and the second node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS flows and a Data Radio Bearer (DRB), so as to support diversified traffics. SRBs can be viewed as services or interfaces provided by the PDCP layer to higher layers, such as the RRC layer. In NR systems SRBs include SRB1, SRB2, and SRB3, which are respectively used to transmit different types of control signaling. The SRB is a bearer between the UE and an access network and is used to transmit control signalings, including RRC signaling, between the UE and the access network. SRB1 has special significance for UEs. After each UE establishes an RRC connection, it will have a SRB1 for transmitting RRC signaling, and most of the signalings are transmitted through SRB1. If SRB1 is interrupted or unavailable, the UE has to carry out RRC re-establishment. SRB2 is generally only used to transmit NAS signaling or signaling related to security. The UE does not have to configure SRB3. Unless for urgent traffics, the UE must establish an RRC connection with the network to proceed with communications. Although not described in FIG. 3, the first node may comprise several higher layers above the L2 355. Besides, the first node comprises a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first data SDU of this application is generated at a protocol layer above the SDAP356.

In one embodiment, the first data PDU of this application is generated at the first protocol layer.

In one embodiment, the second data SDU of this application is generated at the first protocol layer.

In one embodiment, the second data PDU of this application is generated at the second protocol layer.

In one embodiment, the first signaling in the present application is generated by the RRC 306.

In one embodiment, the first packet in the present application is generated by the MAC352 or the PHY351.

In one embodiment, the second packet in the present application is generated by the MAC352 or the PHY351.

In one embodiment, the third data SDU of this application is generated at a protocol layer above the SDAP356.

In one embodiment, the third data PDU of this application is generated at the first protocol layer.

In one embodiment, the fourth data SDU of this application is generated at the first protocol layer.

In one embodiment, the fourth data PDU of this application is generated at the second protocol layer.

### Embodiment 4

Embodiment 4 illustrates a schematic diagram of a first communication device and a second communication device according to one embodiment of the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, and optionally a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, and optionally a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer (Layer-2). In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with the memory 460 that stores program code and data; the memory 460 may be called a computer readable medium. In the transmission from the second communication device 410 to the second communication device 450, the controller/processor 459 provides demultiplexing between a transport channel and a logical channel, packet reassembling, decrypting. header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the LI layer. The controller/processor 475 provides functions of the L2 layer. The controller/processor 475 can be associated with the memory 476 that stores program code and data; the memory 476 may be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory. The at least one memory comprises computer program codes; the at least one memory and the computer program codes are configured to be used in collaboration with the at least one processor. The first communication device 450 at least performs a header compression for a first data SDU at a first protocol layer; and submits a first data PDU to a second protocol layer, where the first data PDU is generated by the first data SDU having been through the header compression; and performs encryption processing for a second data SDU at the second protocol layer, where the second data SDU is the first data PDU received at the second protocol layer; and submits a second data PDU to a lower layer, where the second data PDU is generated by the second data SDU having been through the encryption processing; herein, the first protocol layer is an upper layer of the second protocol layer; the second protocol layer is an upper layer of a MAC layer; the first protocol layer and the second protocol layer are both protocol layers of an access stratum; service provided by the second protocol layer to the first protocol layer is a radio bearer.

In one embodiment, the first communication device 450 comprises a memory that stores a computer readable instruction program. The computer readable instruction program generates actions when executed by at least one processor. The actions include: performing a header compression for a first data SDU at a first protocol layer; and submitting a first data PDU to a second protocol layer, where the first data PDU is generated by the first data SDU having been through the header compression; and performing encryption processing for a second data SDU at the second protocol layer, where the second data SDU is the first data PDU received at the second protocol layer; and submitting a second data PDU to a lower layer, where the second data PDU is generated by the second data SDU having been through the encryption processing; herein, the first protocol layer is an upper layer of the second protocol layer; the second protocol layer is an upper layer of a MAC layer; the first protocol layer and the second protocol layer are both protocol layers of an access stratum; service provided by the second protocol layer to the first protocol layer is a radio bearer.

In one embodiment, the first communication device 450 corresponds to the first node in the present application.

In one embodiment, the second communication device 410 corresponds to the second node in the present application.

In one embodiment, the first communication device 450 is a UE.

In one embodiment, the first communication device 450 is a vehicle-mounted terminal.

In one embodiment, the first communication device 450 is a cellphone.

In one embodiment, the second communication device 410 is a relay.

In one embodiment, the second communication device 410 is a satellite.

In one embodiment, the second communication device 410 is an aircraft.

In one embodiment, the second communication device 410 is a base station.

In one embodiment, the receiver 454 (comprising the antenna 452), the receiving processor 456 and the controller/processor 459 are used for receiving the first signaling in the present application.

In one embodiment, the transmitter 454 (comprising the antenna 452), the transmitting processor 468 and the controller/processor 459 are used for transmitting the first data SDU in the present application.

In one embodiment, the transmitter 454 (comprising the antenna 452), the transmitting processor 468 and the controller/processor 459 are used for transmitting the first data PDU in the present application.

In one embodiment, the transmitter 454 (comprising the antenna 452), the transmitting processor 468 and the controller/processor 459 are used for transmitting the second data SDU in the present application.

In one embodiment, the transmitter 454 (comprising the antenna 452), the transmitting processor 468 and the controller/processor 459 are used for transmitting the second data PDU in the present application.

In one embodiment, the transmitter 454 (comprising the antenna 452), the transmitting processor 468 and the controller/processor 459 are used for transmitting the third data SDU in the present application.

In one embodiment, the transmitter 454 (comprising the antenna 452), the transmitting processor 468 and the controller/processor 459 are used for transmitting the third data PDU in the present application.

In one embodiment, the transmitter 454 (comprising the antenna 452), the transmitting processor 468 and the controller/processor 459 are used for transmitting the fourth data SDU in the present application.

In one embodiment, the transmitter 454 (comprising the antenna 452), the transmitting processor 468 and the controller/processor 459 are used for transmitting the fourth data PDU in the present application.

In one embodiment, the transmitter 454 (comprising the antenna 452), the transmitting processor 468 and the controller/processor 459 are used for transmitting the first packet in the present application.

### Embodiment 5

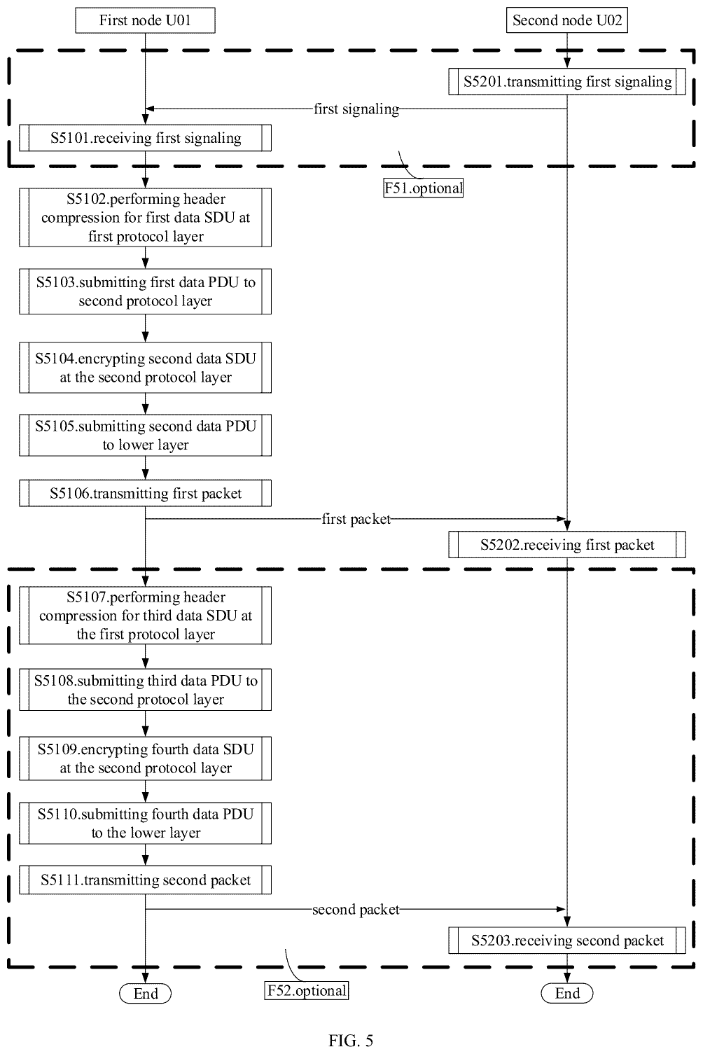

Embodiment 5 illustrates a flowchart of radio signal transmission according to one embodiment of the present application, as shown in FIG. 5. In FIG. 5, U01 corresponds to the first node in the present application. It should be particularly noted that the sequence illustrated herein does not set any limit on the orders in which signals are transmitted and implementations in this present application. Herein, steps in F51 and F52 are optional.

The first node U01 receives a first signaling in step S5101; performs header compression for a first data SDU at a first protocol layer in step S5102; submits a first data PDU to a second protocol layer in step S5103; encrypts a second data SDU at the second protocol layer in step S5104; submits a second data PDU to a lower layer in step S5105; transmits a first packet in step S5106; performs header compression for a third data SDU at the first protocol layer in step S5107; submits a third data PDU to the second protocol layer in step S5108; encrypts a fourth data SDU at the second protocol layer in step S5109; submits a fourth data PDU to the lower layer in step S5110; and transmits a second packet in step S5111.

The second node U02 transmits a first signaling in step S5201; receives a first packet in step S5202; and receives a second packet in step S5203.

In Embodiment 5, the first data PDU is generated by the first data SDU having been through the header compression; the second data SDU is the first data SDU received at the second protocol layer; and the second data PDU is generated by the second data SDU having been through the encryption processing; the first protocol layer is an upper layer of the second protocol layer; the second protocol layer is an upper layer of a MAC layer; the first protocol layer and the second protocol layer are both protocol layers of an access stratum; service provided by the second protocol layer to the first protocol layer is a radio bearer.

In one embodiment, the first node U01 receives the first signaling in RRC connected state.

In one embodiment, the second node U02 is a base station corresponding to the PCell of the first node U01.

In one embodiment, the second node U02 is the second cell or a base station of which the second cell is a part.

In one embodiment, the second node U02 is a network device of a 6G network.

In one embodiment, the first signaling comprises an RRC signaling.

In one embodiment, the first signaling comprises a NAS signaling.

In one embodiment, the first signaling configures at least one of header compression and encryption.

In one embodiment, the first signaling configures integrity protection.

In one embodiment, the first signaling establishes a first radio bearer and the first data SDU uses the first radio bearer.

In one embodiment, the network configuring header compression via signaling is prior art in the field.

In one embodiment, the network configuring encryption via signaling is prior art in the field.

In one embodiment, the first node U01 performs header compression and/or encryption via stored parameters.

In one subembodiment, the stored parameters are parameters stored in a SIM card.

In one subembodiment, the stored parameters are parameters received and stored in the RRC connected state.

In one embodiment, the step S5101 is before the step S5102.

In one embodiment, the step S5102 is before the step S5103.

In one embodiment, the step S5103 is before the step S5104.

In one embodiment, the step S5104 is before the step S5105.

In one embodiment, the step S5105 is before the step S5106.

In one embodiment, any one of steps S5107 through step S5111 is not temporally sequential to any one of steps S5102 through S5106.

In one embodiment, steps S5107 through S5110 are earlier than step S5106.

In one subembodiment, step S5111 is absent and the fourth data PDU is transmitted via the first packet.

In one embodiment, steps S5107 through S5110 are later than step S5106.

In one subembodiment, step S5111 is present and the fourth data PDU is transmitted via the second packet.

In one embodiment, the step S5107 is before the step S5108.

In one embodiment, the step S5108 is before the step S5109.

In one embodiment, the step S5109 is before the step S5110.

In one embodiment, the step S5110 is before the step S5111.

In one embodiment, the step S5106 and the step S5111 may be processed in parallel.

In one embodiment, the first packet and the second packet may be multiplexed together.

In one embodiment, the first packet and the second packet may be multiplexed in the same MAC PDU.

In one embodiment, whether the first packet and the second packet can be multiplexed in the same MAC PDU is network configurable.

In one embodiment, the first packet and the second packet are multiplexed in the same MAC PDU when sufficient resources are available.

In one embodiment, the first packet and the second packet are not multiplexed in the same MAC PDU

when radio resources are only sufficient to transmit the first packet.

In one embodiment, the step S5201 is before the step S5202.

In one embodiment, the step S5202 is before the step S5203.

In one embodiment, the first packet is a packet at a lower layer.

In one embodiment, the first packet is a packet at a lower layer of the second protocol layer.

In one embodiment, the first packet is a MAC PDU.

In one embodiment, the first packet carries the second data PDU.

In one embodiment, sending data to the network via a lower layer packet is prior art in the field.

In one subembodiment, the lower layer packet is the first packet.

In one embodiment, the third data PDU is generated from the third data SDU having been through header compression.

In one subembodiment, the third data PDU is the third data SDU that has undergone header compression.

In one subembodiment, the third data PDU is generated from the third data SDU that has undergone header compression and a header of the first protocol layer.

In one subembodiment, the third data SDU that has undergone header compression and a header of the first protocol layer are encapsulated together into the third data PDU.

In one subembodiment, the third data PDU carries the third data SDU.

In one embodiment, the phrase submitting a first data PDU to a second protocol layer comprises: submitting the first data PDU to a first protocol entity of the second protocol layer; and the phrase submitting a third data PDU to the second protocol layer comprises: submitting the third data PDU to the first protocol entity of the second protocol layer.

In one subembodiment, the first data PDU and the third data PDU use a same radio bearer.

In one subembodiment, the first data PDU and the third data PDU are submitted to the second protocol layer using a same service access point.

In one subembodiment, the first data PDU and the third data PDU are each generated by a different protocol entity of the first protocol layer.

In one subembodiment, the first data PDU and the third data PDU are each generated by the same protocol entity of the first protocol layer.

In one embodiment, the header compression performed at the first protocol layer for the first data SDU and the header compression performed at the first protocol layer for the third data SDU use different header compression profiles.

In one subembodiment, the first signaling indicates a header compression profile for header compression performed on the first data SDU at the first protocol layer.

In one subembodiment, the first signaling indicates a header compression profile for header compression performed on the third data SDU at the first protocol layer.

In one subembodiment, the use of different header compression profiles for the header compression performed at the first protocol layer for the first data SDU and the header compression performed at the first protocol layer for the third data SDU helps increase flexibility and provides support for the use of different high-layer protocols, e.g., IP addresses, for the first data SDU and the third data SDU, to ensure better support for multi-modality services.

In one embodiment, multiple header compression profiles are allowed to be configured for the same radio bearer.

In one embodiment, a person of ordinary skill in the art should understand what a header compression profile is.

In one embodiment, the first node U01, performs header compression on a third data SDU at a first protocol layer.

In one subembodiment, the first node U01, submits a third data PDU to the second protocol layer, where the third data PDU is generated from the third data SDU having been through the header compression.

In one subembodiment, the third data PDU is the third data SDU that has undergone header compression.

In one subembodiment, the third data PDU is generated from the third data SDU that has undergone header compression and a header of the first protocol layer.

In one subembodiment, the third data SDU that has undergone header compression and a header of the first protocol layer are encapsulated together into the third data PDU.

In one subembodiment, the third data PDU carries the third data SDU.

In one embodiment, the phrase submitting a first data PDU to a second protocol layer comprises: submitting the first data PDU to a first protocol entity of the second protocol layer; and the phrase submitting a third data PDU to the second protocol layer comprises: submitting the third data PDU to the second protocol entity of the second protocol layer.

In one subembodiment, the first data SDU and the third data SDU correspond to the same QoS flow.

In one subembodiment, the first data SDU and the third data SDU correspond to the same QoS sub-flow.

In one subembodiment, the first data PDU and the third data PDU use different radio bearers.

In one subembodiment, the first data PDU and the third data PDU are submitted to the second protocol layer via different service access points, respectively.

In one embodiment, the benefits of the above method include: it is possible to transmit the same service, or the same PDU session, using different radio bearers, which facilitates the provision of different services for different data of the same service, thus saving resources and improving efficiency, and facilitates the support of more complex services, and facilitates better support of multi-modality services.

In one embodiment, the first data SDU and the third data SDU correspond to the same QoS flow.

In one embodiment, the first data SDU and the third data SDU correspond to the same QoS sub-flow.

In one embodiment, the first node U01 performs segmentation for the second data SDU at the second protocol layer.

In one subembodiment, the first node U01 performs segmentation of the second data SDU according to an indication from a lower layer of the second protocol layer.

In one subembodiment, the first node U01 performs segmentation of the second data SDU based on the size of wireless resources.

In one subembodiment, the first node U01 performs segmentation of the second data SDU based on wireless resources, to enable the second data SDU to be adapted to the wireless resources after segmentation.

In one subembodiment, the first node U01 performs segmentation of the second data SDU based on an indication from the network.

In one subembodiment, a header of the second data PDU comprises a portion of bits of the second data SDU.

In one subembodiment, the header of the second data PDU comprises numbering of segments of the second data SDU.

In one subembodiment, the numbering of the segments of the second data SDU included in the header of the second data PDU is relative to the second data SDU.

In one embodiment, the first node U01 performs a second header compression on the second data SDU at the second protocol layer, where the second header compression is a header compression based on protocols other than the first header compression protocol.

In one embodiment, the header compression of the first data SDU performed by the first node U01 at a first protocol layer is a first header compression based on a first header compression protocol.

In one embodiment, the header compression performed at the first protocol layer on the first data SDU is a first header compression.

In one embodiment, the first header compression is based on a first header compression protocol.

In one embodiment, the first header compression uses the first header compression protocol.

In one embodiment, the second header compression does not use the first header compression protocol.

In one embodiment, the second header compression uses a protocol other than the first header compression protocol.

In one embodiment, the first header compression protocol is RoHC.

In one embodiment, the first header compression protocol is EHC.

In one embodiment, the first header compression protocol is UDC.

In one embodiment, the header compression other than the first header compression protocol is a RoHC-based header compression, the first header compression protocol is EHC or the first header compression protocol is UDC.

In one embodiment, the header compression other than the first header compression protocol is an EHC-based header compression, the first header compression protocol is RoHC or the first header compression protocol is UDC.

In one embodiment, the header compression other than the first header compression protocol is a UDC-based header compression, the first header compression protocol is EHC or the first header compression protocol is RoHC.

In one embodiment, for the first data SDU, a first header compression is performed at the first protocol layer and a second header compression is performed at the second protocol layer, which is beneficial for enhanced compatibility and better supports simultaneous use of multiple header compression algorithms.

In one embodiment, step S5111 is not necessary when the second data PDU and the fourth data PDU are multiplexed together.

In one embodiment, the second data PDU and the fourth data PDU are multiplexed in the first packet.

In one embodiment, the sentence that the header compression performed at the first protocol layer for the first data SDU and the header compression performed at the first protocol layer for the third data SDU use different header compression profiles means that the profile of the header compression performed on the first data SDU at the first protocol layer and the profile of the header compression performed on the third data SDU at the first protocol layer are configured independently.

In one embodiment, the sentence that the header compression performed at the first protocol layer for the first data SDU and the header compression performed at the first protocol layer for the third data SDU use different header compression profiles means that the header compression performed on the first data SDU at the first protocol layer and the header compression performed on the third data SDU at the first protocol layer correspond to respective header compression channels.

In one embodiment, the sentence that the header compression performed at the first protocol layer for the first data SDU and the header compression performed at the first protocol layer for the third data SDU use different header compression profiles means that the header compression performed on the first data SDU at the first protocol layer and the header compression performed on the third data SDU at the first protocol layer correspond to respective header compression entities.

In one embodiment, the first protocol entity at the second protocol layer, the SDU of the second protocol layer carrying the first data PDU and the SDU of the second protocol layer carrying the third data PDU are multiplexed in the same PDU of the second protocol layer.

In one embodiment, the header compression performed at the first protocol layer for the first data SDU and the header compression performed at the first protocol layer for the third data SDU use different header compression profiles.

### Embodiment 6

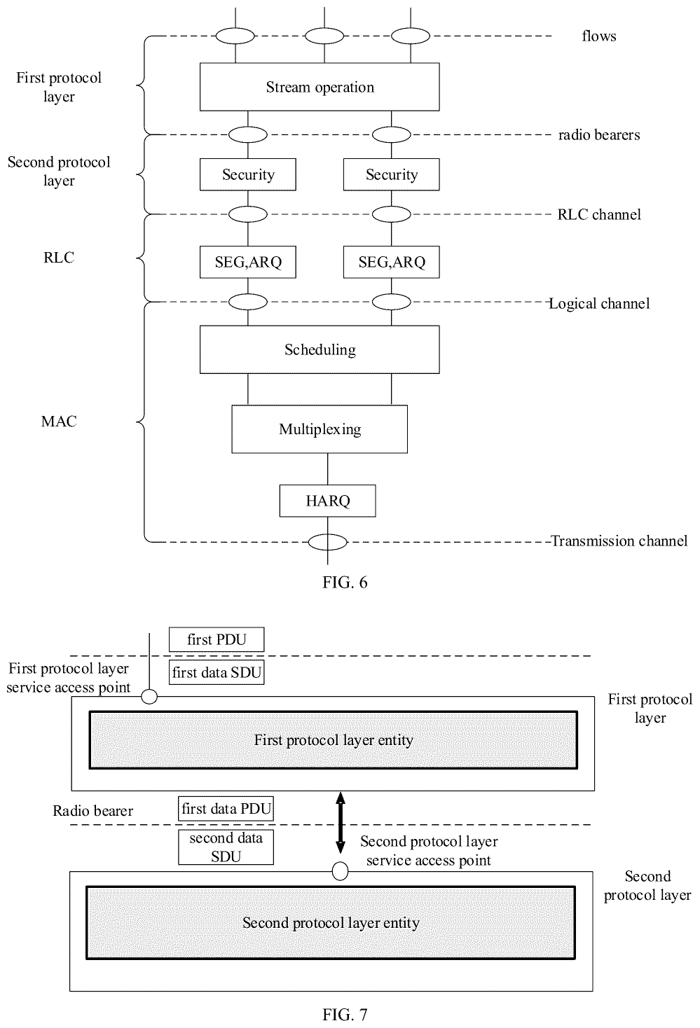

Embodiment 6 illustrates a schematic diagram of a user-plane processing procedure according to one embodiment of the present application, as shown in FIG. 6.

FIG. 6 illustrates the structure of the user plane of the access stratum, where the ellipses denote the interfaces or service access points between the two layers, with the interfaces between the two neighboring layers being different, and the different interfaces implying different kinds of functionality, and FIG. 6 also illustrates the functionality of each layer, and in specific embodiments, each layer may also include functionality not illustrated within this figure, where the RLC layer is optional in some of the embodiments.

In one embodiment, the interface between the first protocol layer and an upper layer of the first protocol layer is defined as a flow, i.e., the first protocol layer receives the flow from the upper layer.

In one subembodiment, the flow is a QoS flow.

In one subembodiment, the flow corresponds to a service.

In one subembodiment, the flow corresponds to a session.

In one subembodiment, the first data SDU is received by the first protocol layer via the flow.

In one subembodiment, the flow is an information flow or an IP flow.

In one embodiment, FIG. 6 presents the first protocol layer with 3 interfaces to its upper layers, the number 3 being used to indicate the presence of a plurality of, but not limited to 3, interfaces.

In one embodiment, the first protocol layer supports the mapping of multiple flows to the same entity of the second protocol layer.

In one embodiment, the stream operation of the first protocol layer is to map the flows to corresponding radio bearers.

In one embodiment, which flows are mapped and to which radio bearers the flows are mapped by the first protocol layer is network configured.

In one embodiment, which flows are mapped and to which radio bearers the flows are mapped by the first protocol layer is predefined.

In one embodiment, which flows are mapped and to which radio bearers the flows are mapped by the first protocol layer is fixed.

In one embodiment, multiple PDUs in a flow received by the first protocol layer use different IP addresses.

In one embodiment, multiple PDUs in a flow received by the first protocol layer use different TCP ports.

In one embodiment, multiple PDUs in a flow received by the first protocol layer use different TCP/IP addresses.

In one embodiment, multiple PDUs in a flow received by the first protocol layer use more than one TCP/IP address.

In one embodiment, multiple PDUs in a flow received by the first protocol layer use more than one IP address.

In one embodiment, multiple PDUs in a flow received by the first protocol layer use more than one TCP port.

In one embodiment, any PDU in a flow received by the first protocol layer uses only one IP address.

In one embodiment, any PDU in a flow received by the first protocol layer uses only one TCP port.

In one embodiment, any PDU in a flow received by the first protocol layer uses only one TCP/IP address.

In one embodiment, the first data SDU is a data PDU from a higher layer received by the first protocol layer.

In one embodiment, the first data SDU is an IP packet from a higher layer received by the first protocol layer.

In one embodiment, the first data SDU is non-3GPP data from a higher layer received by the first protocol layer.

In one embodiment, the first data SDU is a PDU received by the first protocol layer from a higher layer that can be header compressed by the RoHC.

In one embodiment, the first data SDU is a PDU received by the first protocol layer from a higher layer that can be supported by the RoHC.

In one embodiment, the second protocol layer may comprise one or more entities.

In one embodiment, which entity of the second protocol layer the first data PDU is submitted to is indicated by the network.

In one subembodiment, the network indicates via the first signaling which entity of the second protocol layer the first data PDU is submitted to.

In one embodiment, which entity of the second protocol layer the first data PDU is submitted to is determined by the first node itself.

In one embodiment, the first data PDU may be submitted to multiple entities of the second protocol layer.

In one embodiment, the first data PDU is submitted to one entity of the second protocol layer.

In one embodiment, one entity of the second protocol layer corresponds to one radio bearer.

In one embodiment, which radio bearer is used by the first data PDU is network-indicated.

In one subembodiment, the network indicates via the first signaling which radio bearer is used by the first data PDU.

In one embodiment, which radio bearer is used by the first data PDU is determined by the first node itself.

In one embodiment, the first data PDU may be submitted to multiple radio bearers.

In one embodiment, the first data PDU is submitted to one radio bearer.

In one embodiment, the interface between the first protocol layer and the second protocol layer is a radio bearer.

In one embodiment, a radio bearer is the service provided by the second protocol layer to the first protocol layer.

In one embodiment, the second protocol layer does not support header compression.

In one embodiment, the second protocol layer only supports a header compression that is different from the header compression of the first protocol layer.

In one embodiment, the second protocol layer only supports a header compression that uses a different header compression protocol than the header compression of the first protocol layer.

In one embodiment, the functions of the second protocol layer include, in addition to security function, at least one of transmitting in order, retransmitting, discarding, segmenting, discarding duplicate data, or calculating data capacity.

In one embodiment, the second protocol layer uses a transmission window mechanism.

In one embodiment, the security of the second protocol layer includes encryption.

In one embodiment, the security of the second protocol layer includes at least the former of encryption and integrity protection.

In one embodiment, the action submitting a second data PDU to a lower layer is submitting the second data PDU to the RLC layer.

In one embodiment, the action submitting a second data PDU to a lower layer is submitting the second data PDU to the MAC layer.

In one subembodiment, the RLC layer is absent.

In one subembodiment, there is no other protocol layer between the second protocol layer and the MAC layer.

In one embodiment, the interface between the second protocol layer and the RLC layer is an RLC channel.

In one embodiment, the second data PDU is submitted to the RLC layer over the RLC channel.

In one embodiment, the second data PDU is received by an RLC entity of the RLC layer.

In one embodiment, the second protocol layer is not an RLC layer.

In one embodiment, the second protocol layer is an upper layer of the RLC layer.

In one embodiment, the function of the RLC layer comprises segmentation.

In one embodiment, the function of the RLC layer comprises Automatic Repeat reQuest (ARQ).

In one embodiment, the RLC layer includes a Transparent Mode (TM), an Unacknowledged Mode (UM), and an Acknowledged Mode (AM).

In one embodiment, the function of the RLC layer includes using a sequence number.

In one embodiment, the function of the RLC layer includes protocol error detection.

In one embodiment, the function of the RLC layer includes duplicate detection.

In one embodiment, the interface between the RLC layer and the MAC layer is a logical channel.

In one embodiment, when the access stratum does not comprise an RLC layer, the second data PDU is submitted to the MAC layer via an interface between the second protocol layer and the MAC layer.

In one embodiment, the function of the MAC layer includes scheduling.

In one embodiment, the scheduling algorithm is prior art in the field.

In one embodiment, the function of the MAC layer includes multiplexing, where the MAC layer multiplexes received MAC SDUs within a MAC PDU based on the size of available wireless resources.

In one embodiment, the function of the MAC layer also comprises Hybrid Automatic Repeat reQuest (HARQ).

In one embodiment, HARQ is prior art in the field.

In one embodiment, the interface between the MAC layer and a lower layer of the MAC layer is a transmission channel.

In one subembodiment, the lower layer of the MAC layer is a physical layer.

In one embodiment, the first packet is a MAC PDU.

In one embodiment, the first packet is transmitted to the network through the physical layer.

In one embodiment, the first packet carries at least a portion of bits of the second data PDU.

In one embodiment, the first packet carries at least one segment of the second data PDU.

In one embodiment, the first packet carries at least a portion of bits of the fourth data PDU.

In one embodiment, the first packet carries at least one segment of the fourth data PDU.

In one embodiment, the second data PDU may be submitted to one RLC entity for processing or may be submitted to multiple RLC entities for processing separately after replication.

In one embodiment, the above user-plane processing method, with respect to a 6G network, is conducive to supporting richer services, to increasing flexibility, to reducing processing delay, and to improving user-plane performance.

### Embodiment 7

Embodiment 7 illustrates a schematic diagram of a first protocol layer and a second protocol layer according to one embodiment of the present application, as shown in FIG. 7.

In one embodiment, the first data SDU is a first PDU at an upper layer of the first protocol layer.

In one embodiment, the first PDU is an IP packet.

In one embodiment, the first PDU is an application layer packet.

In one embodiment, the first PDU is not an access stratum PDU.

In one embodiment, the first PDU is submitted to a protocol entity of the first protocol layer via a service access point of the first protocol layer.

In one embodiment, the first data SDU is the first PDU from a higher layer received by the first protocol layer entity.

In one embodiment, the interface between the first protocol layer and the second protocol layer is a radio bearer.

In one embodiment, a radio bearer is the service provided by the second protocol layer to the first protocol layer.

In one embodiment, the first data PDU is submitted to an entity of the second protocol layer i.e. transmitted over a radio bearer.

In one embodiment, the second data SDU is the first data PDU received by the second protocol layer.

In one embodiment, any processing performed at the first protocol layer is the any processing performed at at least one entity of the first protocol layer.

In one embodiment, any processing performed at the second protocol layer is the any processing performed at at least one entity of the second protocol layer.

In one embodiment, one protocol layer exchanges signaling and/or data with other protocol layers via a service access point.

In one embodiment, an entity of one protocol layer exchanges signaling and/or data with entities of other protocol layers via a service access point.

In one embodiment, a protocol entity of the first protocol layer processes the first data SDU and the third data SDU.

In one subembodiment, the first data SDU and the third data SDU belong to different services.

In one subembodiment, the first data SDU and the third data SDU belong to the same service.

In one subembodiment, the benefits of the above method include: low implementation complexity and small memory usage.

In one subembodiment, the second data PDU and the fourth data PDU are processed by the same protocol entity of the second protocol layer.

In one subembodiment, the benefits of the above method include: low implementation complexity, with only one protocol entity of the second protocol layer required to be created.

In one subembodiment, the second data PDU and the fourth data PDU are processed by different protocol entities of the second protocol layer.

In one subembodiment, the benefits of the above method include: better ensuring the processing of the second data PDU and the fourth data PDU without interfering with each other.

In one embodiment, different protocol entities of the first protocol layer process the first data SDU and the third data SDU.

In one subembodiment, the first data SDU and the third data SDU belong to different services.

In one subembodiment, the first data SDU and the third data SDU belong to the same service.

In one subembodiment, the benefits of the above method include: short processing time, which is beneficial for parallel processing.

In one subembodiment, the second data PDU and the fourth data PDU are processed by the same protocol entity of the second protocol layer.

In one subembodiment, the benefits of the above method include: low implementation complexity, with only one protocol entity of the second protocol layer required to be created.

In one subembodiment, the second data PDU and the fourth data PDU are processed by different protocol entities of the second protocol layer.

In one subembodiment, the benefits of the above method include: better ensuring the processing of the second data PDU and the fourth data PDU without interfering with each other.

In one embodiment, a data PDU of the first protocol layer processed by the first protocol layer entity is dynamically submitted to multiple protocol entities of the second protocol layer.

In one embodiment, the mapping relationship between the first protocol layer entity and the entities of the second protocol layer is dynamic.

In one embodiment, the first node determines to which entity of the second protocol layer the data PDUs of the first protocol layer entity are submitted based on one of a payload, an internal algorithm, a lower layer indication, a queuing delay, or a network signaling.

In one embodiment, the benefits of the above method include: helping balance payload, ensuring transmission quality, and reducing transmission delay.

### Embodiment 8

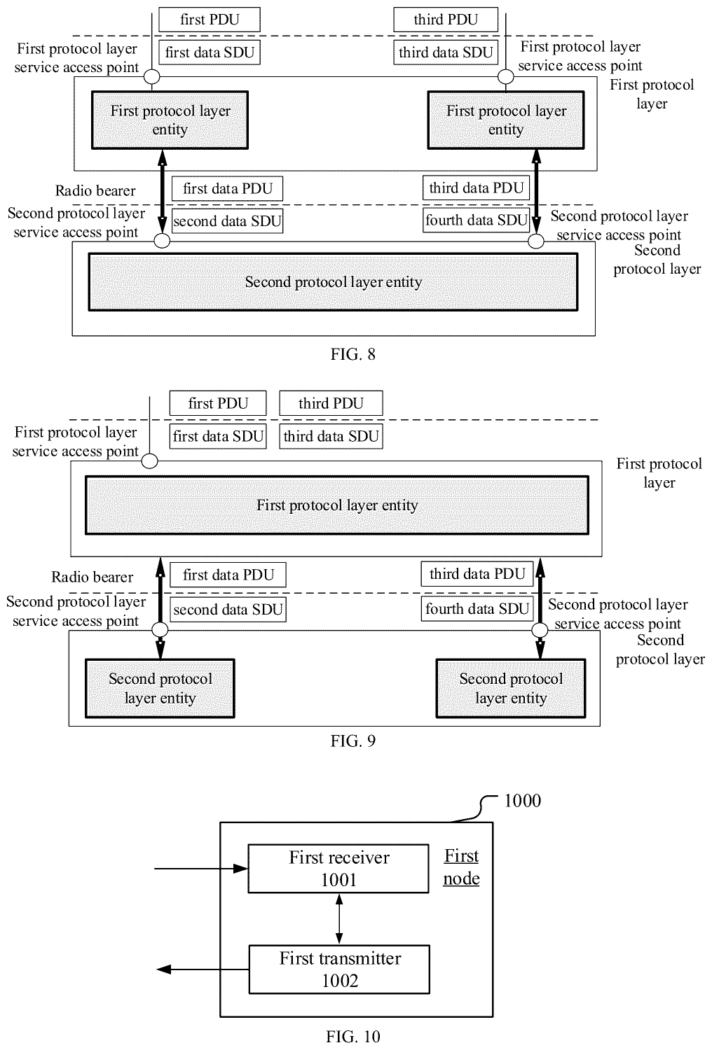

Embodiment 8 illustrates a schematic diagram of a first protocol layer and a second protocol layer according to one embodiment of the present application, as shown in FIG. 8.

In one embodiment, the first data SDU is a first PDU at an upper layer of the first protocol layer.

In one embodiment, the first PDU is an IP packet.

In one embodiment, the first PDU is an application layer packet.

In one embodiment, the first PDU is not an access stratum PDU.

In one embodiment, the first PDU is submitted to a protocol entity of the first protocol layer via a service access point of the first protocol layer.

In one embodiment, the first data SDU is the first PDU from a higher layer received by the first protocol layer entity.

In one embodiment, the third data SDU is a third PDU at an upper layer of the first protocol layer.

In one embodiment, the third PDU is an IP packet.

In one embodiment, the third PDU is an application layer packet.

In one embodiment, the third PDU is not an access stratum PDU.

In one embodiment, the third PDU is submitted to a protocol entity of the first protocol layer via a service access point of the first protocol layer.

In one embodiment, the third data SDU is the third PDU from a higher layer received by the first protocol layer entity.

In one embodiment, the interface between the first protocol layer and the second protocol layer is a radio bearer.

In one embodiment, a radio bearer is the service provided by the second protocol layer to the first protocol layer.

In one embodiment, the third data PDU is submitted to an entity of the second protocol layer i.e. transmitted over a radio bearer.

In one embodiment, the fourth data SDU is the third data PDU received by the second protocol layer.

In one embodiment, the third data PDU is submitted to an entity of the second protocol layer i.e. transmitted over a radio bearer.

In one embodiment, the fourth data SDU is the third data PDU received by the second protocol layer.

In one embodiment, one protocol layer exchanges signaling and/or data with other protocol layers via a service access point.

In one embodiment, an entity of one protocol layer exchanges signaling and/or data with entities of other protocol layers via a service access point.

In one embodiment, the first data SDU and the third data SDU belong to the same service.

In one embodiment, the first data SDU and the third data SDU belong to the same session.

In one embodiment, the first data SDU and the third data SDU belong to the same PDU session.

In one embodiment, the second data SDU and the fourth data SDU are processed by the same protocol entity of the second protocol layer.

In one embodiment, the first data SDU is processed by a first entity of the first protocol layer and generates the first data PDU.

In one embodiment, the third data SDU is processed by a second entity of the first protocol layer and generates the third data PDU.

In one embodiment, the first data SDU and the third data SDU carry different IP addresses.

In one embodiment, the first data SDU and the third data SDU carry different TCP ports.

In one embodiment, the first data SDU and the third data SDU carry different TCP/IP addresses.

In one embodiment, the first data SDU and the third data SDU belong to or correspond to different QoS flows.

In one embodiment, the first data SDU and the third data SDU belong to or correspond to different QoS sub-flows.

In one embodiment, the first data SDU and the third data SDU use different header compression profiles.

In one embodiment, the first data SDU and the third data SDU are header compressed by different header compression entities, respectively.

In one subembodiment, the different header compression entities belong to a first entity and a second entity of the first protocol layer, respectively.

In one embodiment, the first data SDU and the third data SDU are header compressed through different header compression channels, respectively.

In one subembodiment, the different header compression channels correspond to a first entity and a second entity of the first protocol layer, respectively.

In one embodiment, the benefits of the above method include: helping provide support for more complex service types, in particular better support of multi-modality services, improving the header compression efficiency, avoiding the resetting of header compression context due to the change of protocol header of a packet, for instance when the headers of different packets carry different IP addresses; simplifying the design of the PDCP layer when the second protocol layer is a PDCP layer, the second protocol layer can better reuse the PDCP of the NR system.

In one embodiment, how many entities the first protocol layer has is dependent on the configuration of the network.

In one subembodiment, the network may configure according to internal algorithms, or by experience.

In one subembodiment, the network may configure based on the multi-modality nature of the service or QoS flow to which the first data SDU belongs.

In one subembodiment, the network may configure two first protocol layer entities in a fixed manner.

In one subembodiment, the network may configure based on the number of IP addresses of the service or QoS flow to which the first data SDU belongs.

In one embodiment, how many entities the first protocol layer has is determined by the first node.

In one subembodiment, the first node indicates to the network how many entities are established in the first protocol layer.

In one subembodiment, the how many entities of the first protocol layer are for services/QoS flows/sessions for the first data SDU.

In one subembodiment, the first node may configure according to internal algorithms, or by experience.

In one subembodiment, the first node may configure based on the multi-modality nature of the service or QoS flow to which the first data SDU belongs.

In one subembodiment, the first node may configure two first protocol layer entities in a fixed manner.

In one subembodiment, the first node may configure based on the number of IP addresses of the service or QoS flow to which the first data SDU belongs.

### Embodiment 9

Embodiment 9 illustrates a schematic diagram of a first protocol layer and a second protocol layer according to one embodiment of the present application, as shown in FIG. 9.

In one embodiment, the first data SDU is a first PDU at an upper layer of the first protocol layer.

In one embodiment, the first PDU is an IP packet.

In one embodiment, the first PDU is an application layer packet.

In one embodiment, the first PDU is not an access stratum PDU.

In one embodiment, the first PDU is submitted to a protocol entity of the first protocol layer via a service access point of the first protocol layer.

In one embodiment, the first data SDU is the first PDU from a higher layer received by the first protocol layer entity.

In one embodiment, the third data SDU is a third PDU at an upper layer of the first protocol layer.

In one embodiment, the third PDU is an IP packet.

In one embodiment, the third PDU is an application layer packet.

In one embodiment, the third PDU is not an access stratum PDU.

In one embodiment, the third PDU is submitted to a protocol entity of the first protocol layer via a service access point of the first protocol layer.

In one embodiment, the third data SDU is the third PDU from a higher layer received by the first protocol layer entity.

In one embodiment, the interface between the first protocol layer and the second protocol layer is a radio bearer.

In one embodiment, a radio bearer is the service provided by the second protocol layer to the first protocol layer.

In one embodiment, the third data PDU is submitted to an entity of the second protocol layer i.e. transmitted over a radio bearer.

In one embodiment, the fourth data SDU is the third data PDU received by the second protocol layer.

In one embodiment, the third data PDU is submitted to an entity of the second protocol layer i.e. transmitted over a radio bearer.

In one embodiment, the fourth data SDU is the third data PDU received by the second protocol layer.

In one embodiment, one protocol layer exchanges signaling and/or data with other protocol layers via a service access point.

In one embodiment, an entity of one protocol layer exchanges signaling and/or data with entities of other protocol layers via a service access point.

In one embodiment, the first data SDU and the third data SDU belong to the same service.

In one embodiment, the first data SDU and the third data SDU belong to the same session.

In one embodiment, the first data SDU and the third data SDU belong to the same PDU session.

In one embodiment, the first data SDU and the third data SDU are processed by the same protocol entity of the first protocol layer.

In one embodiment, the second data SDU and the fourth data SDU are processed by different protocol entities of the second protocol layer.

In one embodiment, the second data SDU is processed by a first protocol entity of the second protocol layer.

In one embodiment, the fourth data SDU is processed by a second protocol entity of the second protocol layer.

In one embodiment, respective fields other than the sequence numbers in the protocol headers of the first PDU and the third PDU have the same values.

In one embodiment, the first data SDU and the third data SDU carry different IP addresses.

In one embodiment, the first data SDU and the third data SDU carry different TCP ports.

In one embodiment, the first data SDU and the third data SDU carry different TCP/IP addresses.

In one embodiment, the first data SDU and the third data SDU use different header compression profiles.

In one embodiment, the first data SDU and the third data SDU belong to or correspond to the same QoS flow.

In one embodiment, the first data SDU and the third data SDU belong to or correspond to the same QoS sub-flow.

In one embodiment, the first data SDU and the third data SDU are header compressed by the same header compression entity.

In one embodiment, the first data SDU and the third data SDU are header compressed by different header compression entities, respectively.

In one embodiment, the first data SDU and the third data SDU are header compressed through the same header compression channel.

In one embodiment, the first data SDU and the third data SDU are header compressed through different header compression channels, respectively.

In one embodiment, the benefits of the above method include: to process the same service using one entity of the first protocol layer is conducive to balancing different data within the same service; to process through different protocol entities of the second protocol layer is conducive to providing different transmission services for different data of the same service, for example, to provide different qualities, which can better satisfy the service with complex requirements, and at the same time is conducive to reduced resource consumption.

In one embodiment, the first data PDU is dynamically submitted to at least one of multiple protocol entities of the second protocol layer.

In one embodiment, the mapping relationship between the first protocol layer entity and multiple protocol entities of the second protocol layer is dynamic.

In one embodiment, the first node determines to which entity of the second protocol layer the first data PDU is submitted based on one of a payload, an internal algorithm, a lower layer indication, a queuing delay, or a network signaling.

In one embodiment, the benefits of the above method include: being more flexible, helping balance payload, ensuring transmission quality, and reducing transmission delay.

In one embodiment, how many entities the second protocol layer has is dependent on the configuration of the network.

In one subembodiment, the how many entities of the first protocol layer are for services/QoS flows/sessions for the first data SDU.

In one subembodiment, the network may configure according to internal algorithms, or by experience.

In one subembodiment, the network may configure based on the multi-modality nature of the service to which the first data SDU belongs.

In one subembodiment, the network may configure two second protocol layer entities in a fixed manner.

### Embodiment 10

Embodiment 10 illustrates a structure block diagram of a processing device used in a first node according to one embodiment of the present application, as shown in FIG. 10. In FIG. 10, a processing device 1000 in a first node is comprised of a first receiver 1001 and a first transmitter 1002.

In Embodiment 10, the first transmitter 1002 performs a header compression for a first data SDU at a first protocol layer; and submits a first data PDU to a second protocol layer, where the first data PDU is generated by the first data SDU having been through the header compression; and performs encryption processing for a second data SDU at the second protocol layer, where the second data SDU is the first data PDU received at the second protocol layer; and submits a second data PDU to a lower layer, where the second data PDU is generated by the second data SDU having been through the encryption processing;
herein, the first protocol layer is an upper layer of the second protocol layer; the second protocol layer is an upper layer of a MAC layer; the first protocol layer and the second protocol layer are both protocol layers of an access stratum; service provided by the second protocol layer to the first protocol layer is a radio bearer.

In one embodiment, the first transmitter 1002 performs a header compression for a third data SDU at the first protocol layer; and submits a third data PDU to the second protocol layer, where the third data PDU is generated by the third data SDU having been through the header compression;
herein, the phrase submitting a first data PDU to a second protocol layer comprises: submitting the first data PDU to a first protocol entity of the second protocol layer; and the phrase submitting a third data PDU to the second protocol layer comprises: submitting the third data PDU to the first protocol entity of the second protocol layer; the header compression performed at the first protocol layer for the first data SDU and the header compression performed at the first protocol layer for the third data SDU use different header compression profiles.

In one embodiment, the first data SDU and the third data SDU use different IP addresses; the first data SDU and the third data SDU correspond to different QoS flows or different QoS sub-flows.

In one embodiment, the first transmitter 1002 performs a header compression for a third data SDU at the first protocol layer; and submits a third data PDU to the second protocol layer, where the third data PDU is generated by the third data SDU having been through the header compression;
herein, the phrase submitting a first data PDU to a second protocol layer comprises: submitting the first data PDU to a first protocol entity of the second protocol layer; and the phrase submitting a third data PDU to the second protocol layer comprises: submitting the third data PDU to the second protocol entity of the second protocol layer; the first data SDU and the third data SDU correspond to a same QoS flow.

In one embodiment, the first transmitter 1002 performs segmentation for the second data SDU at the second protocol layer;
herein, the second protocol layer is a PDCP layer.

In one embodiment, the first transmitter 1002 performs a second header compression for the second data SDU at the second protocol layer, where the second header compression is a header compression other than based on RoHC;
herein, the header compression performed at the first protocol layer for the first data SDU is a first header compression based on RoHC.

In one embodiment, the first protocol layer is an SDAP layer.

In one embodiment, the second protocol layer is a PDCP layer.

In one embodiment, the first protocol layer supports mapping between a QoS flow and a radio bearer, and supports marking a QoS flow identity.

In one embodiment, the second protocol layer supports Sequence Number, supports integrity protection, supports replication and supports packet discarding.

In one embodiment, the first node is a UE.

In one embodiment, the first node is a UE supporting 6G networks.

In one embodiment, the first node is a terminal supporting large delay difference.

In one embodiment, the first node is a terminal supporting NTN.

In one embodiment, the first node is an aircraft or vessel.

In one embodiment, the first node is a cellphone or vehicle-mounted terminal.

In one embodiment, the first node is a terminal supporting MUSIM.

In one embodiment, the first node is an IoT terminal or IIOT terminal.

In one embodiment, the first node is a piece of equipment supporting transmissions with low delay and high reliability.

In one embodiment, the first receiver 1001 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1002 comprises at least one of the antenna 452, the transmitter 454, the transmitting processor 468, the multi-antenna transmitting processor 457, the controller/processor 459, the memory 460 or the data source 467 in Embodiment 4.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IOT), RFID terminals, NB-IOT terminals, Machine Type Communication (MTC) terminals, enhanced MTC (eMTC) terminals, data cards, low-cost mobile phones, low-cost tablet computers, satellite communication equipment, ship communication equipment, and NTN UE, etc. The base station or system device in the present application includes but is not limited to macro-cellular base stations, micro-cellular base stations, home base stations, relay base station, gNB (NR node B), Transmitter Receiver Point (TRP), NTN base station, satellite equipment and fight platform, and other radio communication equipment.

This disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for header compression in wireless communications, comprising:
a first transmitter, performing a header compression for a first data Service Data Unit (SDU) at a first protocol layer; and submitting a first data PDU to a second protocol layer, where the first data PDU is generated by the first data SDU having been through the header compression; and performing encryption processing for a second data SDU at the second protocol layer, where the second data SDU is the first data PDU received at the second protocol layer; and submitting a second data PDU to a lower layer, where the second data PDU is generated by the second data SDU having been through the encryption processing;
wherein the first protocol layer is an upper layer of the second protocol layer; the second protocol layer is an upper layer of a Medium Access Control (MAC) layer; the first protocol layer and the second protocol layer are both protocol layers of an access stratum; service provided by the second protocol layer to the first protocol layer is a radio bearer.

2. The first node according to claim 1, characterized in comprising:
the first transmitter, performing a header compression for a third data SDU at the first protocol layer; and submitting a third data PDU to the second protocol layer, where the third data PDU is generated by the third data SDU having been through the header compression;
wherein the submitting a first data PDU to a second protocol layer comprises: submitting the first data PDU to a first protocol entity of the second protocol layer; and the submitting a third data PDU to the second protocol layer comprises: submitting the third data PDU to the first protocol entity of the second protocol layer; the header compression performed at the first protocol layer for the first data SDU and the header compression performed at the first protocol layer for the third data SDU use different header compression profiles.

3. The first node according to claim 2, characterized in that
the first data SDU and the third data SDU use different Internet Protocol (IP) addresses; the first data SDU and the third data SDU correspond to different Quality of Service (QoS) flows or different QoS sub-flows.

4. The first node according to claim 1, characterized in comprising:
the first transmitter, performing a header compression for a third data SDU at the first protocol layer; and submitting a third data Protocol Data Unit (PDU) to the second protocol layer, where the third data PDU is generated by the third data SDU having been through the header compression;
wherein the submitting a first data PDU to a second protocol layer comprises: submitting the first data PDU to a first protocol entity of the second protocol layer; and the submitting a third data PDU to the second protocol layer comprises: submitting the third data PDU to the second protocol entity of the second protocol layer; the first data SDU and the third data SDU correspond to a same QoS flow.

5. The first node according to claim 1, characterized in comprising:
the first transmitter, performing segmentation for the second data SDU at the second protocol layer;
wherein the second protocol layer is a PDCP layer.

6. The first node according to claim 1, characterized in comprising:
the first transmitter, performing a second header compression for the second data SDU at the second protocol layer, where the second header compression is a header compression other than based on RoHC;
wherein the header compression performed at the first protocol layer for the first data SDU is a first header compression based on RoHC.

7. The first node according to claim 2, characterized in comprising:
the first transmitter, performing a second header compression for the second data SDU at the second protocol layer, where the second header compression is a header compression other than based on RoHC;
wherein the header compression performed at the first protocol layer for the first data SDU is a first header compression based on RoHC.

8. The first node according to claim 4, characterized in comprising:
the first transmitter, performing a second header compression for the second data SDU at the second protocol layer, where the second header compression is a header compression other than based on RoHC;
wherein the header compression performed at the first protocol layer for the first data SDU is a first header compression based on RoHC.

9. The first node according to claim 1, characterized in that
the first protocol layer is an SDAP layer.

10. The first node according to claim 2, characterized in that
the first protocol layer is an SDAP layer.

11. The first node according to claim 1, characterized in that
the second protocol layer is a PDCP layer.

12. The first node according to claim 2, characterized in that
the second protocol layer is a PDCP layer.

13. The first node according to claim 4, characterized in that
the second protocol layer is a PDCP layer.

14. The first node according to claim 6, characterized in that
the second protocol layer is a PDCP layer.

15. The first node according to claim 9, characterized in that
the second protocol layer is a PDCP layer.

16. The first node according to claim 1, characterized in that
the first protocol layer supports mapping between a QoS flow and a radio bearer, and supports marking a QoS flow identity.

17. The first node according to claim 1, characterized in that
the second protocol layer supports Sequence Number, supports integrity protection, supports replication and supports packet discarding.

18. The first node according to claim 4, characterized in that
the second protocol layer supports Sequence Number, supports integrity protection, supports replication and supports packet discarding.

19. The first node according to claim 7, characterized in that
the second protocol layer supports Sequence Number, supports integrity protection, supports replication and supports packet discarding.

20. A method in a first node for header compression in wireless communications, comprising:
performing a header compression for a first data SDU at a first protocol layer; and submitting a first data PDU to a second protocol layer, where the first data PDU is generated by the first data SDU having been through the header compression; and performing encryption processing for a second data SDU at the second protocol layer, where the second data SDU is the first data PDU received at the second protocol layer; and submitting a second data PDU to a lower layer, where the second data PDU is generated by the second data SDU having been through the encryption processing;
wherein the first protocol layer is an upper layer of the second protocol layer; the second protocol layer is an upper layer of a MAC layer; the first protocol layer and the second protocol layer are both protocol layers of an access stratum; service provided by the second protocol layer to the first protocol layer is a radio bearer.
